(19) United States
(12) Patent Application Publication
(10) Pub. No.: US 2007/0023259 A1
(43) Pub. Date: Feb. 1, 2007

(54) Three-side stacker

(75) Inventor: Michael Schonauer, Moosburg (DE)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Jungheinrich Aktiengesellschaft, Hamburg (DE)

(21) Appl. No.: 11/492,694

(22) Filed: Jul. 25, 2006

(30) Foreign Application Priority Data
Jul. 29, 2005 (DE) 10 2005 035 631.1

(51) Int. Cl. B65G 47/34; B66F 9/14

(52) U.S. Cl. 198/468.6; 414/662

(57) ABSTRACT

A three-side stacker with a side push frame at one end of the stacker, on which a side arm is horizontally movably mounted, wherein the side arm has a first portion mounted by the side push frame and a second portion which is mounted pivotally around a vertical axis on the first portion and holds a load supporting means, a pivoting equipment for the second portion, mounted on the first portion, an upper and a lower horizontal guideway on the side push frame, with which guide rolls on the first portion of the side arm co-operate, as well as with an upper and lower toothed rack into which gear wheels engage which sit splinedly on a common shaft which is rotatably mounted in the first portion, and with a rotational drive for the torsion shaft on the first portion, wherein guideways are arranged on the side push frame in parallel to the toothed racks, and spacer rollers sit on the shaft, which co-operate with the guideways and determine the distance of the gearwheels from the toothed racks.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Such a three-side stacker has become known from DE 31 41 215 A, the entire content of which is incorporated herein by reference in its entirety, for instance. For instance, it is used as a storage rack conveyor. A side push or guide frame is arranged on the front end, transversely to the longitudinal axis of the apparatus. Depending on the type, the side push frame is connected stationarily with the vehicle or guided in the height on a lifting mast or so. Finally, it is also possible to fix the side push frame on the front side of the cab of the vehicle, which is itself as a whole traversable in the height on the lifting mast. In this case, the three-side stacker represents an order picking apparatus. A side arm is horizontally traversable on the side push frame. The side arm consists of two portions, namely a first portion, which is guided on the side push frame, and a second portion, which is mounted to be rotatable around a vertical axis. On the second portion, there is either directly attached a holder for a load supporting means, a fork for instance, or an additional mast, for instance, on which the fork holder can be moved in the height. With the aid of a drive, which is preferably a hydraulic one, the second portion and with this the load fork or the mast, respectively, can be pivoted around a vertical axis in an angle range of 0 to 180°. The hydraulic lines for the supply of the drives on the movable parts are integrated and guided in a suitable manner such that they can follow the horizontal movement of the side arm. For the transmission of weight from the side arm to the side push frame, rolls are arranged on the side arm, which co-operate with U-shaped guideways. Toothed racks, arranged parallel in a distance and running horizontally, are attached on the side push frame, with which sprockets or gearwheels on the side arm co-operate. The sprockets or gearwheels sit splinedly on a common torsion shaft, which is in turn driven by a suitable drive. With the aid of the drive, the side arm can be moved horizontally. At the same time, the torsion shaft provides stabilization around an axis parallel to the longitudinal axis of the vehicle.

The dynamics of the pushing movement of the side arm results in a wear of toothed racks and gearwheels. In the course of time, an out-of-round running results, which accelerates the wear still further.

The present invention is based on the objective to provide a three-side stacker in which the wear of gearwheels and toothed racks is minimized, the smooth running of the side arm on the side push frame being ensured in doing so.

### BRIEF SUMMARY OF THE INVENTION

In the present invention, guideways are arranged on the side push frame in parallel to the toothed racks, and spacer rollers sit on the shaft, which co-operate with the guideways and determine the distance of the gearwheels from the toothed racks.

In the present invention, it is taken care that the gearwheels have always a defined distance from the toothed racks.

The spacer rollers can sit rotatably or preferably splinedly on the torsion shaft. According to one embodiment of the present invention, the spacer rollers are each arranged on that side of the gearwheels which is turned away from the end of the torsion shaft, and the guideways are each arranged in the space between the toothed racks.

The guideways can be formed by rails, which are fixed on the side push frame. Preferably, each toothed rack contains at least one parallel guideway, with which the spacer rollers co-operate. According to a further embodiment of the present invention, the toothed racks can form a running path for a guide roller of the side arm at the same time. In this context, one embodiment of the present invention provides that the upper toothed rack has an upper plane, on which lays a guide roller which is rotatable around a horizontal axis.

The torsion shaft is rotatably mounted in the first portion of the side arm. For this purpose, one embodiment of the present invention provides that the torsion shaft is mounted in an upper and a lower bearing component part, a mounting plate fixed on the side arm for example, the guide roller on its part being rotatably mounted on the bearing component part.

Several advantages are achieved by the invention. The wear on the tooth profiles of gearwheel and toothed rack is reduced, through which the durability is increased. Furthermore, the running smoothness of the side arm on the side push frame is improved. By pre-fabricated component parts, the adjustment work in the assembly can be reduced. The present invention makes possible a compact and inexpensive construction, because the torsion shaft is used as a supporting component part.

### BRIEF DESCRIPTION OF THE SEVERAL VIEWS OF THE DRAWINGS

One example of realization of the present invention will be explained in more detail by means of drawings below.

FIG. 1 shows a side push frame with side arm for a three-side stacker according to the invention in a perspective view.

FIG. 2 shows a final view of the representation according to FIG. 1.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

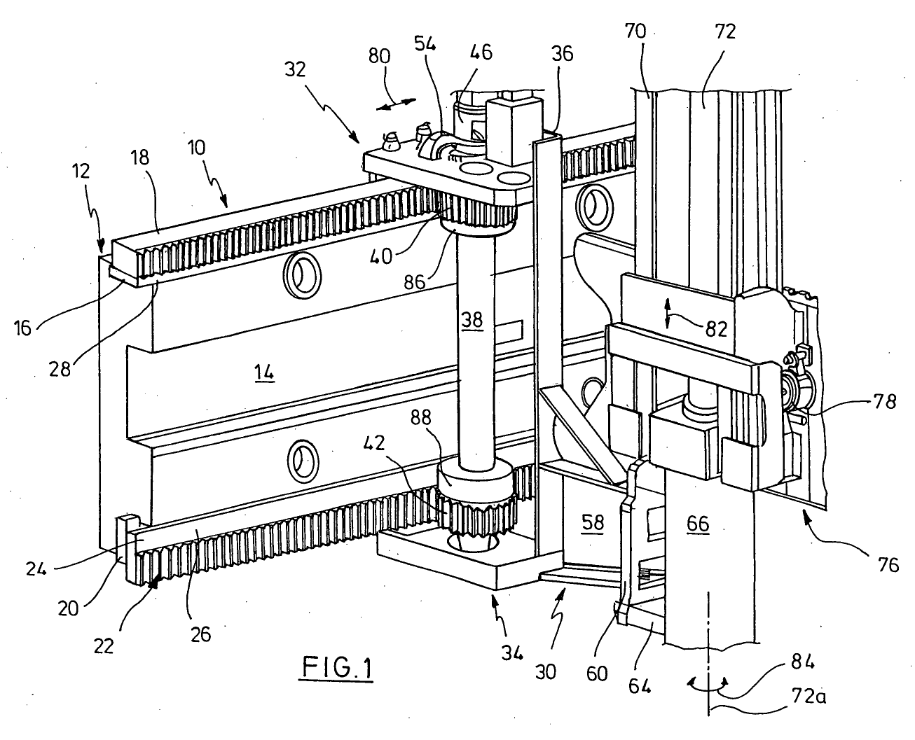

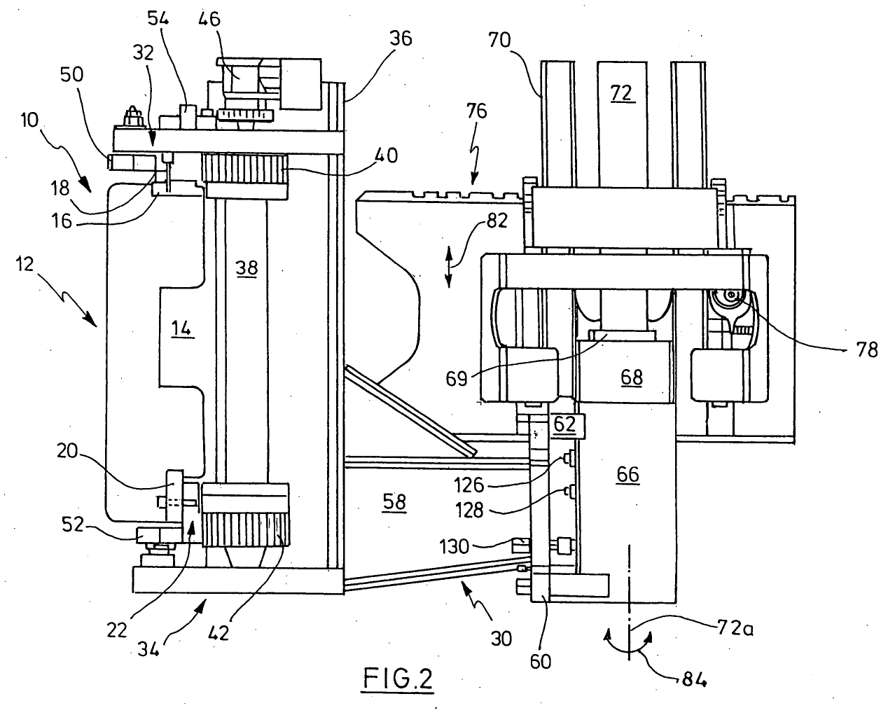

In the FIGS. 1 and 2, a side push frame 10 of a three-side stacker is designated with 10. The three-side stacker is not shown for the rest. Insofar, reference is made to DE 31 41 215 A1, for instance. The side push frame 10 is fixed horizontally on the front side of the three-side stacker, for instance on the vehicle itself or on a lifting mast or even on a cab, which is height-movably guided on the lifting mast.

The side push frame has a frame profile 12, U-shaped in its cross section, through which a channel 14 is formed. On the upper side of the frame profile 12, a flat rail 16 is fixed, by screwing for instance. A toothed rack 18 is fixed on the rail 16, also by screwing for instance, which is not shown in more detail here. Rail 16 and toothed rack 18 run horizontally. A further flat rail is fixed on the lower side of the frame profile 12. While the flat sides of the rail 16 run horizontally, the flat sides of the rail 20 extend vertically. A toothed rack 22 is fixed on the rail 20. The toothing of the toothed rack 22 does not extend completely over the width of the rack, instead a slightly retracted portion 24 is provided, which a forms a horizontally extending vertical running path 26. On the side directed towards the toothing of the toothed rack 18, the rail 16 forms also a running path 28. This one too is somewhat retracted against the toothing of the toothed rack 18. The running paths 26, 28 extend in a common plane. However, they can also lay in parallel planes. In addition, they run in parallel to the parallel toothed racks 18, 22.

A side arm 30, generally extending vertically to the frame profile 12, has an upper mounting plate 32 and a lower mounting plate 34, which are fixed on a stable casing, which is indicated at 36. The mounting plates 32, 34 rotatably bear a torsion shaft 38, on which an upper gearwheel 40 and a lower gearwheel 42 are splinedly arranged. The gearwheels 40, 42 mesh with the toothing of the toothed racks 18, 22. The torsion shaft 38 is rotationally driven by a hydraulic drive 46. On the mounting plate 32, two guide rollers are rotatably mounted around a vertical axis on the lower side, one of which can be recognized at 50 in FIG. 2. The guide rollers 50 co-operate with a guideway of the toothed rack 18, which is on the rear side in FIG. 1. On the lower mounting plate 34, two guide rollers are also rotatably mounted, one of which is shown in FIG. 2 at 52. They co-operate with a guideway on the backside (FIG. 1) of the toothed rack 22. The guide rollers 50, 52 take up the weight momentum of the side arm 30 around an axis parallel to the longitudinal axis of the side push frame 10.

In the mounting plate 32, a further guide roller 54 is rotatably mounted around a horizontal axis. It co-operates with an upper guideway of the toothed rack 18 and takes up the weight force of the side arm. Preferably, two such rolls can also be provided.

An arm 58 is fixed on the casing 36 of the side arm 30, extending horizontally on the lower end, on which a further mounting plate 60 is fixed, which extends transversely. The mounting plate 60 carries a rotational drive 66 via an upper arm 62 or a lower arm 64. Via a block 68, its casing supports a lifting mast 70, into which a lifting cylinder 72 is inserted, which in turn supports itself on the block 68. With the aid of the rotational drive 66, the lifting mast 70 can be turned around a vertical axis 72a, preferably between 0 and 180°. On the lifting mast 70, a sliding cradle or fork carrier 76 is guided in the height, which can be shifted in the height with the aid of a not shown chain and the lifting cylinder 72. Such a lifting drive is commonly known in floor conveyors, and thus it will not be described in more detail. In FIG. 1 or 2, a sensor mounting is indicated at 78, by which the lifting height of the sliding cradle 76 is determined.

The supply of hydraulic energy for the drives 46, 66 and the cylinder 72 has naturally to take place from the carrier vehicle, wherein the hydraulic lines are integrated in a corresponding manner (not shown) and are guided through the profile frame 12. They can be guided in a loop (not shown), which is moved in the channel 14, so that the side arm 30 can freely move along the side push frame 10. When the torsion shaft 38 is driven, the side arm 30 moves horizontally, corresponding to the double arrow 80. When the cylinder 72 is actuated, the fork lifting carrier 76 moves around the axis 72a, corresponding to the double arrow 84.

When the drive 46 is actuated, the gearwheels 40, 42 rotate, through which the side arm 30 is moved along the toothed racks 18, 22. The guide rollers 50, 52 and 54 support themselves on the facing guideways or guiding planes of the toothed racks 18, 22.

As can be further recognized in FIGS. 1 and 2, an upper spacer roller 86 and a lower spacer roller 88 sit on the torsion shaft 38. The spacer roller 86 rolls on a guideway 26, 28. With the aid of the spacer rollers 86, 88, a predetermined distance between the gearwheels 40, 42 and the toothed racks 18, 22 is set.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A three-side stacker with a side push frame at one end of the stacker, on which a side arm is horizontally traversably mounted, wherein the side arm has a first portion mounted by the side push frame and a second portion which is mounted pivotally around a vertical axis on the first portion and holds a load supporting means, a pivoting equipment for the second portion, mounted on the first portion, an upper and a lower horizontal guideway on the side push frame, with which guide rolls on the first portion of the side arm co-operate, as well as with an upper and lower toothed rack into which gearwheels engage which sit splinedly on a common shaft which is rotatably mounted in the first portion, and with a rotational drive for the torsion shaft on the first portion, characterized in that guideways (28, 26) are arranged on the side push frame (10) in parallel to the toothed racks (18, 22) and spacer rollers (86, 88) sit on the shaft (38), which co-operate with the guideways and determine the distance of the gearwheels (40, 42) from the toothed racks (18, 22).

2. A three-side stacker according to claim 1, characterized in that the spacer rollers (86, 88) sit rotatably or splinedly on the torsion shaft (38).

3. A three-side stacker according to claim 1, characterized in that the spacer rollers (86, 88) are each arranged on that side of the gearwheels (40, 42) which is turned away from the end of the torsion shaft (38) and the guideways (28, 26) are each arranged in the space between the toothed racks (18, 22).

4. A three-side stacker according to claim 1, characterized in that the guideways are formed by rails, which are fixed on the side push frame.

5. A three-side stacker according to claim 4, characterized in that the parallel guideway is formed on at least one toothed rack (18, 22).

6. A three-side stacker according to claim 3, characterized in that one toothed rack forms a running path for the guide roller of the side arm at the same time.

7. A three-side stacker according to claim 6, characterized in that the upper toothed rack (18) has an upper guideway, on which lays a guide roller (54) which is mounted rotatably around a horizontal axis.

8. A three-side stacker according to claim 1, characterized in that the torsion shaft (38) is mounted in an upper and a lower bearing component part (32, 43), which are in turn fixed on the first portion of the side arm (30) and the guide rollers (50, 52, 54) are mounted on the bearing component parts (32, 34).
